(19) United States
(12) Patent Application Publication
(10) Pub. No.: US 2024/0326883 A1
(43) Pub. Date: Oct. 3, 2024

(54) OBSTACLE DETECTION IN THE TRACK AREA ON THE BASIS OF DEPTH DATA

(71) Applicant: Siemens Mobility GmbH, München (DE)

(72) Inventors: San-Yu Huang, Berlin (DE); Benjamin Hartmann, Berlin (DE); Irina Vidal Migallon, Berlin (DE)

(21) Appl. No.: 18/574,098

(22) PCT Filed: Apr. 6, 2022
(86) PCT No.: PCT/EP2022/059110

§ 371 Date: Dec. 26, 2023

(30) Foreign Application Priority Data
Jun. 23, 2021 (DE) 10 2021 206 475.2

(51) Int. Cl. B61L 23/04; B61L 15/00; G06V 20/58

(52) U.S. Cl. CPC B61L 23/041; B61L 15/0072; G06V 20/58

(57) ABSTRACT

A method for detecting obstacles for a rail vehicle includes capturing 3D image data from an area surrounding the rail vehicle and generating 2D image data from the 3D image data. Rails are detected and localized in the 2D image data. Depth data are determined in the 2D image data based on the 3D image data. The 2D image data are divided into linear image segments, each having a rail section with a constant depth. A depth value of a pixel of a linear image segment outside the rails is then compared with the respective depth value of the rails. If the difference between the depth value of the pixel and the depth value of the rails exceeds a threshold value, the pixel is part of an object projecting above the level of the terrain. Depending on its position and/or movement, the object is considered a potential collision obstacle.

The invention relates to a method for obstacle identification for a rail vehicle. In addition, the invention relates to an obstacle identification facility. The invention relates, moreover, to a rail vehicle.

In rail traffic, objects, such as people or road vehicles, shopping carts, which were thrown on the rails, or even lumps of rock or fallen trees, occasionally end up on the track system and thus represent a danger to the safety of the rail traffic and in the case of the people and road vehicles, are also themselves in extreme danger owing to the possibility of a collision with a moving rail vehicle. Objects of this kind thus have to be identified in good time in order to initiate a braking process for an approaching rail vehicle, so a collision between the rail vehicle and the identified objects can be prevented.

Detection of possible obstacles of any form or shape, which block the rails, is therefore a safety-critical necessity for all types of rail vehicle. The detection of obstacles plays a crucial role, in particular, in autonomous driving or in the automated assistance of the control of rail vehicles. There are many possible solutions to this problem, with possible solutions based on artificial intelligence (abbreviated to AI) being the most promising. Any AI-based solution is only as good as its training database, which for rail traffic scenarios is very laborious to compile and to annotate.

Supervised object detection with the return of what are known as bounding boxes based on machine learning has proven to be quite effective for most designated objects. However, it is quite costly to characterize or train a new class in a development cycle for a model. First of all, a database, which comprises the corresponding obstacles, has to be searched. The data then has to be annotated either by suitable specialized staff or this process has to be entrusted to external contractors. The new model has to be appropriately trained and also validated. The model then has to be implemented in the field and tested still in practice. In addition, it is frequently difficult to discover all types of obstacle by way of one model. If new types of obstacle are identified, adequate image material has to also be available for it in which the obstacles are mapped. For each data acquisition, important routes have to be traveled with all necessary sensors in all functional states, and data material has to be acquired for the different types of obstacle, which were recorded under different conditions and from different distances. The costs for these additional journeys are not insignificant. It therefore seems that a constant search for obstacles, which have not yet been classified, and a corresponding continuous supplementation of the models can only be carried out with difficulty.

There are also approaches in which a priori items of information can be used in a supervised context to identify types of obstacle in advance. The a priori knowledge is used to synthesize images for training purposes. These approaches generally cannot be applied, however. In addition, they are limited to scenarios with 2D image data processing. Even if obstacles are correctly identified it can be that without depth information it is not possible to identify whether an object is blocking the rails, in particular in bends.

Direct identification of objects with the aid of methods which are based on AI-based training therefore does not seem achievable for generic use in the rail traffic.

Furthermore there are attempts to identify objects in point clouds, which are generated by LIDAR sensors. There are AI-based methods and conventional model-based methods in this connection. AI-based methods are quite successful in the detection of large objects, such as cars, but they have problems in identifying smaller objects, such as people. In addition, so much data has to be processed in AI-based methods that the processing itself can barely be accomplished in real time even by high-performance computers. Conventional methods for processing point clouds use technologies such as clustering and filtering to detect anomalies. Such methods have a large number of fixed parameters, which can only be optimized by a long-lasting test method, if it is possible at all. LIDAR sensors have a limited range and resolution, so identification methods based thereon are reliable only approximately up to 100 m, even in the case of applications on a main route.

The object is therefore to provide a method and an apparatus for identifying obstacles for rail vehicles, which, generalized, can also be applied to main routes or to rail traffic for relatively large distances.

This object is achieved by a method for obstacle identification for a rail vehicle as claimed in claim 1, an obstacle identification facility as claimed in claim 9 and a rail vehicle as claimed in claim 10.

In the inventive method for obstacle identification for a rail vehicle, 3D image data is captured from a surrounding area of the rail vehicle. Three-dimensional image data should be taken to mean image data, which comprises an item of depth information. This should also incorporate what are known as disparity images, which comprise items of information from different perspectives. Three-dimensional images can then be generated again from these images. The 3D image data does not have to fully describe the present objects in respect of their three-dimensional shape, for which reason a large number of image recordings from at least three different directions would possibly be necessary.

The environment of the rail vehicle captured in images preferably comprises a travel channel of the rail vehicle running in front of the rail vehicle, but can preferably also comprise peripheral areas located to the right and left of the travel channel in order to identify, for example, potential collision obstacles in good time before they have even arrived in the vicinity of the travel channel.

Furthermore, 2D image data is generated on the basis of the 3D image data. For this, the 3D image data is projected onto a 2D plane whose orientation preferably corresponds to the viewing perspective of the rail vehicle. This viewing perspective preferably also comprise the perspective of a driver looking out of the rail vehicle to the front or in the direction of travel and/or the perspective with which at least some of the sensors, which are preferably oriented in direction of travel or in the direction of the longitudinal axis of the rail vehicle, capture the surrounding area.

Rails are detected and localized in the 2D image data. One method for rail detection is described, for example, in application DE 10 2020 215 754.5. In addition, depth data is ascertained in the 2D image data on the basis of the 3D image data. A depth of a point, for example of an object, should be taken to mean a distance of the point from the relevant sensor unit or image recording unit, for example a camera. The 2D image data is divided into line-like image segments with one rail section respectively with a constant depth. The lines preferably run transversely to the image recording direction and are preferably linear or optionally curved in such a way that for the case where the line merely traces the level of the terrain, all points on the line have the same depth. Furthermore, it is ascertained whether a pixel or point is part of an object projecting above the level of the terrain. This is ascertained as a function of whether the difference in the depth value of the relevant pixel from the depth value of the rails of the same image segment overshoots a predetermined threshold value.

In other words, a depth value of a pixel of a line-like image segment outside of the rails is compared with the respective depth value of the rails inside of the line-like image segment. The line-like image segment can comprise, for example, a horizontal line in an image. If there is no additional object present in the image segment, then all pixels in the image segment should have approximately the same depth. In this case, the pixels are all comprehended as being part of the level of the terrain. Otherwise it is ascertained that the pixel is part of an object, possibly of an obstacle, which protrudes above the level of the terrain, that is to say, for the case where the difference in the depth value of the pixel from the depth value of the rails overshoots a predetermined threshold value.

Finally, for the case where the pixel was detected as part of an object, which projects above the level of the terrain, as a function of a position and/or a detected movement, in particular velocity and direction of movement of the object, it is ascertained whether the detected object represents a potential collision obstacle.

Advantageously, all types of object, in particular obstacles, of any form and shape may be detected with the inventive method for obstacle identification since the shape of a object does not have to be learned or known. For the rail detection a method based on machine learning can be applied, which by way of a training method of is rendered capable detecting rails in image data.

Advantageously, the range for image recording of the environment, for example by RGB cameras, is much higher than, for example, for LIDAR systems. In addition, an image recording unit, for example an RGB camera, is much less complex to produce than a LIDAR system. Furthermore, no a priori knowledge about the objects and obstacles is necessary. Instead, object identification on the basis of a combination of rail route segmentation and ascertaining depth data results in the possibility of generic obstacle detection. Annotations for classifications of objects are not absolutely necessary. The actual obstacle detection can take place, for example, as a function of the position of the detected object as well as by tracking a movement of the detected object. If the detected object moves or if it moves in the direction of a track area even, the detected object can be classified as a potential obstacle.

The inventive obstacle identification facility has a sensor data interface to an image recording unit for recording three-dimensional image data from a surrounding area of a rail vehicle. The three-dimensional image data can be recorded directly by a stereo camera. The three-dimensional image data can also be recorded first of all by a mono camera, however, for example from different positions, on the basis of the 2D image data of which a 3D-image is then reconstructed. The inventive obstacle identification facility also comprises a projection unit for generating 2D image data on the basis of the 3D image data. Part of the inventive obstacle identification facility is, moreover, a localization unit for detecting and localizing rails in the 2D image data. The inventive obstacle identification facility also comprises a depth data ascertaining unit for ascertaining depth data in the 2D image data on the basis of the 3D image data and an allocation unit for dividing the 2D image data into line-like image segments with one rail section respectively with a constant depth. Part of the inventive obstacle identification facility is also a comparison unit for comparing the depth value of a pixel of a line-like image segment outside of the rails with the respective depth value of the rails.

Furthermore, the inventive obstacle identification facility comprises a detection unit for detecting whether the pixel is part of an object is projecting above the level of the terrain, as a function of whether the difference in the depth value of the pixel from the depth value of the rails of the same image segment overshoots a predetermined threshold value. Finally, the inventive obstacle identification facility also comprises an obstacle ascertaining unit for ascertaining, for the case where the pixel was detected as part of an object which projects above the level of the terrain, whether the detected object represents a potential collision obstacle, as a function of a position and/or a detected movement of the object. The inventive obstacle identification facility shares the advantages of the inventive method for obstacle identification for a rail vehicle.

The inventive rail vehicle has a sensor unit for capturing 3D image data from the environment of the rail vehicle. In addition, the inventive rail vehicle comprises the inventive obstacle identification facility. Furthermore, the inventive rail vehicle has a control facility for controlling driving behavior of the rail vehicle as a function of whether the obstacle identification facility identified an obstacle in the environment of the rail vehicle. The inventive rail vehicle shares the advantages of the inventive obstacle identification facility.

Some components of the inventive obstacle identification facility can be embodied for the most part in the form of software components. This relates, in particular, to the sensor data interface, the projection unit, the localization unit, the depth data ascertaining unit, the allocation unit, the comparison unit and the detection unit.

In principle, however, some of these components, especially when particularly fast calculations are required, can also be implemented in the form of software-assisted hardware, for example FPGAs or the like. Similarly, the required interfaces, for example when only an acquisition of data from different software components is required, can also be embodied as software interfaces. They can also be embodied as interfaces constructed in terms of hardware, however, which are actuated by suitable software.

An implementation largely in terms of software has the advantage that even computer systems already present in a rail vehicle can be easily retrofitted after a potential supplementation with additional hardware elements, such as an image camera, by way of a software update in order to work inventively. In this regard, the object is also 8 achieved by a corresponding computer program product with a computer program, which can be loaded directly into a memory facility of such a computer system, with program segments in order to carry out the steps of the inventive method, which can be implemented by way of software, when the computer program is executed in the computer system.

Apart from the computer program, such a computer program product can optionally comprise additional constituent parts, such as documentation and/or additional components, also hardware components, such as hardware keys (dongles, etc.) in order to use the software.

A computer-readable medium, for example a memory stick, a hard disk or another transportable or permanently installed data carrier, on which the program segments of the computer program, which can be read in and executed by a computer unit, are stored, can serve for transportation to the storage facility of the computer system and/or for storage on the computer system. The computer unit can have, for example, one or more cooperating microprocessor (s) or the like for this purpose.

The dependent claims and the following description respectively contain particularly advantageous embodiments and developments of the invention. In particular, the claims of one class of claims can also be developed analogously to the dependent claims of a different class of claims and the descriptions thereof. In addition, the various features of different exemplary embodiments and claims can also be combined within the framework of the invention to form new exemplary embodiments.

In one embodiment of the inventive method for obstacle identification for a rail vehicle, the localization of the rails is carried out by semantic segmentation based on Deep Learning (multi-layer learning, deep learning: relates to a method of machine learning, which uses the artificial neural nets with numerous intermediate layers between input layer and output layer). One variant of obstacle identification, which can be implemented with the aid of machine learning, is based on semantic segmentation. In semantic segmentation, pixels are divided into classes. Each pixel is annotated in a training process. Pixels of sections of track are divided into one class, all other pixels are allocated to a class relating to the background of the image. Such a scenario can also be comprehended as a binary foreground/background scenario. Advantageously, it is possible to set a limit of two classes in the training process, whereby the training process is greatly simplified.

In one variant of the inventive method, the 3D image data is captured by a stereo camera. Advantageously, 3D items of information, in particular depth data, can be captured directly from the environment of a rail vehicle. While the detection of rails in 2D image data is simplified, 3D items of information, in particular depth data, is used for identifying objects which have a height which goes beyond the height of the rails.

The 3D image data can also be dynamically captured by a mono camera. In this variant, image data is captured from different directions and a 3D-image is generated from this image data. Technology of this kind is referred to as “monodepth” and is described in Clement Godard et al.: “Digging Into Self-Supervised Monocular Depth Estimation” (can be found on the Internet at the address https://arxiv.org/pdf/1806.01260.pdf).

Preferably, the 3D image data comprises RGB data, as image data, which has color differences. Advantageously, color differences can be used for distinguishing objects and image segments.

The depth data is preferably ascertained by way of a model which is based on machine learning. Such a model can be trained in a supervised or unsupervised manner. Such model-based capture of depth data is described in Tinghui Zhou et al.: “Unsupervised Learning of Depth and Ego-Motion from Video” (can be found on the Internet at the address https://people.eecs.berkeley.edu/˜tinghuiz/projects/SfMLear ner/cvpr17_sfm_final.pdf).

The obstacles can be captured particularly effectively by removing the level of the terrain. Advantageously, the depth data of rail points is compared with the depth data of pixels of an image segment in which the rail points are located. If a difference in depth exceeds a threshold value, the pixels can be classified as object pixels, otherwise they are classified as part of the level of the terrain and are removed from the image, so finally only object pixels remain, which are processed further.

A portion of the 2D image data can also be defined as a safety area and only the safety area is investigated for obstacles. Advantageously, the volume of image data to be evaluated is reduced, speeding up the evaluation process.

The invention will be explained in more detail once again below on the basis of exemplary embodiments with reference to the accompanying figures. In the drawings:

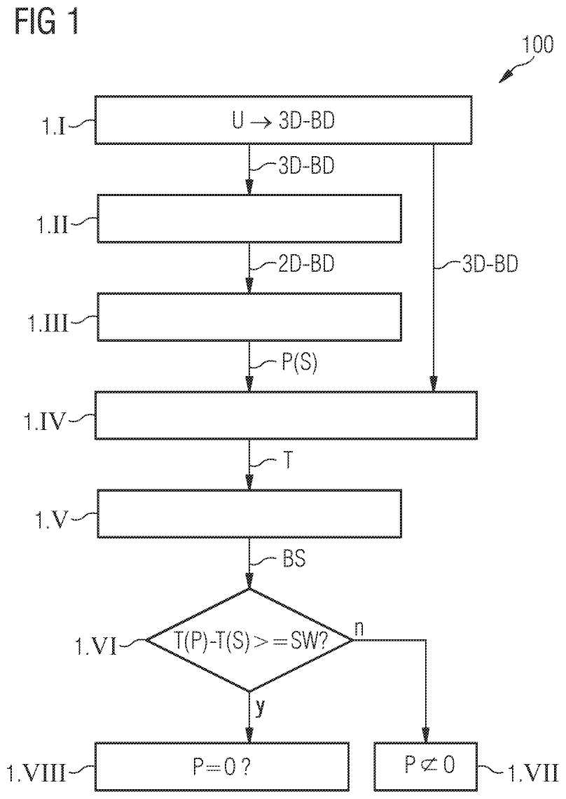

FIG. 1 shows a flowchart, which illustrates a method for obstacle identification for a rail vehicle according to one exemplary embodiment of the invention,

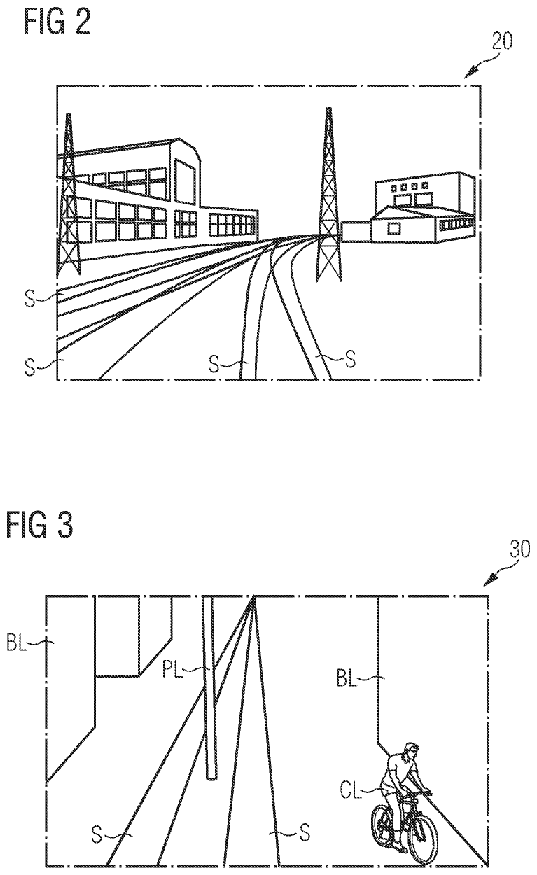

FIG. 2 shows a schematic representation of two-dimensional image data, which is generated in the method illustrated in FIG. 1,

FIG. 3 shows a schematic representation of the recorded image data, wherein pixel-wise depth data is allocated to the rails,

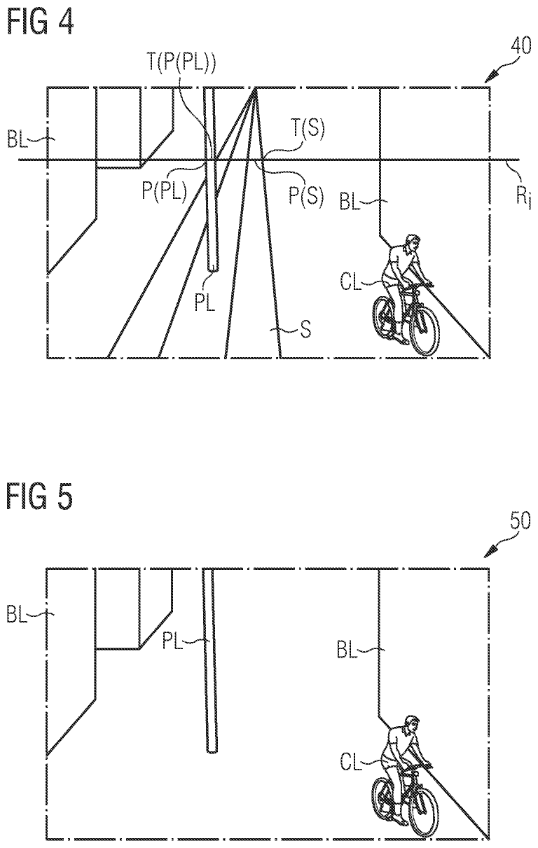

FIG. 4 shows a schematic representation of the image data already illustrated in FIG. 3, wherein different objects were detected,

FIG. 5 shows the representation shown in FIG. 3 and FIG. 4 as a representation with removed level of the terrain,

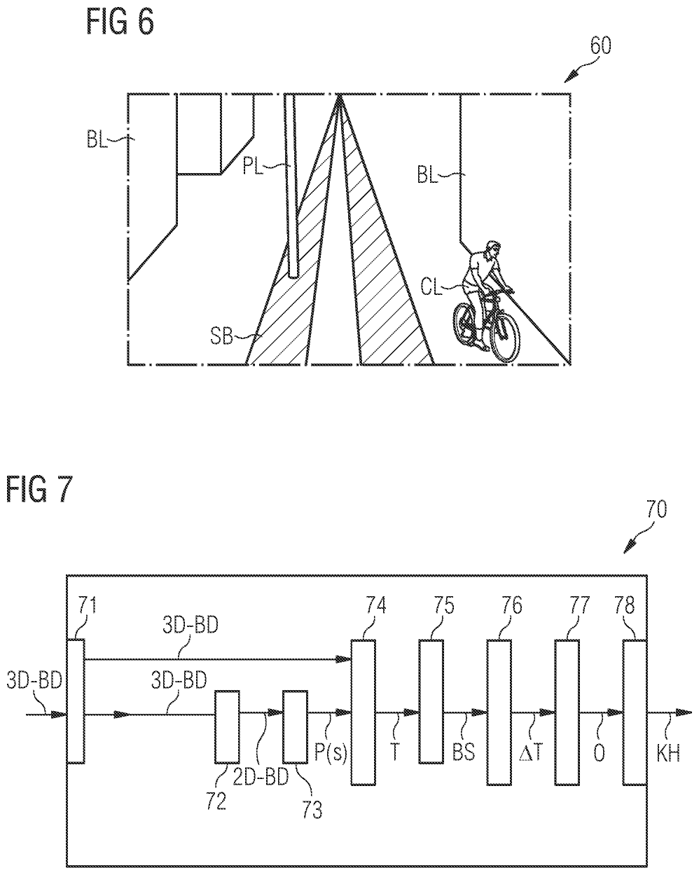

FIG. 6 once again shows the image representation already shown in FIG. 3, FIG. 4, and FIG. 5 as a representation with indicated safety area,

FIG. 7 shows a schematic representation of an obstacle identification facility according to one exemplary embodiment of the invention,

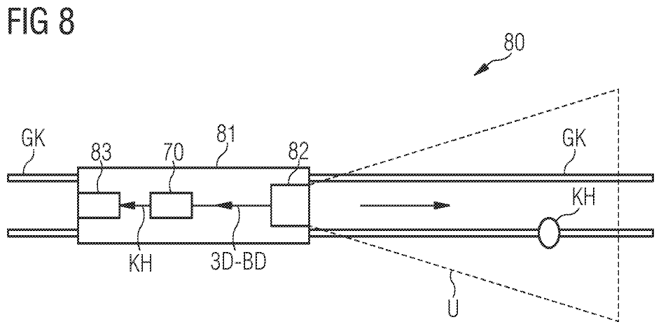

FIG. 8 shows a schematic representation of a rail vehicle according to one exemplary embodiment of the invention.

FIG. 1 shows a flowchart 100, which illustrates a method for obstacle identification for a rail vehicle according to one exemplary embodiment of the invention.

In step 1.I, three-dimensional color 3D image data 3D-BD, also referred to as RGB 3D image data, is captured from the environment or a surrounding area U in front of a rail 8 vehicle 81 (see FIG. 8). The 3D image data 3D-BD is captured by a sensor unit 82 (see FIG. 8) arranged on the rail vehicle 81. The sensor unit 82 comprises an optical camera for recording three-dimensional color image data 3D-BD. The image data 3D-BD comprises items of information about the topography of the surrounding area U of the rail vehicle 81. In this exemplary embodiment, the surrounding area U comprises a front area in front of the rail vehicle 81 into which the rail vehicle 81 wishes to drive.

In step 1. II, 2D image data 2D-BD is generated on the basis of the 3D image data 3D-BD. For this, the 3D image data is projected onto a 2D plane, which is perpendicular to the orientation of the sensor unit 82.

In step 1. III, the rails S running in front of the rail vehicle are detected and localized in the 2D image data. In particular, positions P (S) of the rails S are ascertained.

In step 1. IV, depth data T is ascertained in the 2D image data 2D-BD also on the basis of the 3D image data 3D-BD. 27 That is to say, items of depth information allocated to the individual pixels are obtained from the 3D image data for ascertaining the depth information of individual pixels in the 2D image data.

In step 1.V, the 2D image data 2D-BD is divided into line-like image segments BS with one rail section respectively with a constant depth. For example, there is a straight layout of the line transversely to the railroad, at least for the case where the rail route runs in a straight line, for the line-like image segment. It can then be assumed that with flat terrain all points of the transversely-running straight line have the same depth if there is no object projecting above the level of the terrain.

Subsequently in step 1.VI, the depth value T (P) of a pixel P of a line-like image segment BS outside of the rails S is compared with the respective depth value T (S) of the rails 12 S of this line-like image segment BS. If the difference in the depth values T(P), T(S) overshoots a predetermined threshold value SW, then it is inferred that pixel P pertains to an object O projecting from the plane. In this way, pixels are allocated to different objects O and the objects are localized.

If the threshold value SW was not overshot, the pixel P is not classified as part of an object O in step 1. VII.

Otherwise, it is checked in step 1. VIII whether the detected and localized object O is situated within a safety area around the rails S or is possibly moving in the direction of the rails. If this is the case, the object O is classified in step 1. VIII as a potential collision obstacle KH. Otherwise the object O is not classified as a collision obstacle KH in step 1.VIII. Furthermore, the potential collision obstacles are checked, for example by way of the comparison with map material, to be able to distinguish actual collision obstacles KH from objects O in the existing infrastructure. Further methods for identifying collision obstacles KH track a detected object O. If the object O moves, in particular in the direction of the track area, then it can be classified as a potential collision obstacle KH. If it does not move and is not directly situated in the track area either, the detected object O can be regarded as harmless.

FIG. 2 shows a schematic representation 20 of two-dimensional image data 2D-BD. FIG. 2 illustrates step 1.III of FIG. 1 in which the rails S are localized and identified.

FIG. 3 shows a schematic representation 30 of recorded or generated image data 2D-BD, with pixelwise depth data T (S) being allocated to the rails S. Furthermore, objects can also be identified in the image in FIG. 3, such as a cyclist CL, a mast PL, and building BL. FIG. 3 therefore shows a scenario which should be allocated to step 1. IV in FIG. 1.

FIG. 4 shows a schematic representation 40 of the image data already illustrated in FIG. 3, with different objects BL, CL, PL, such as a cyclist CL, a mast PL and buildings BL, having been detected. As a rule, the pixels of objects have less depth in any series of images than the pixels of the rails S. For example, the pixel P (PL) in series Rᵢ has less depth T (P (PL)) than the rails S. It can therefore be assumed that the pixel P (PL) pertains to an object projecting above the level of the terrain. FIG. 4 therefore illustrates a scenario which corresponds to steps 1.V and 1.VI in FIG. 1.

FIG. 5 shows the representation shown in FIG. 3 and FIG. 4 as a representation 50 with removed level of the terrain, so only the detected objects CL, PL, BL can still be identified in the representation 50, but not the rails S and remaining image areas of the level of the terrain.

FIG. 6 once again shows the image representation already shown in FIG. 3, FIG. 4 and FIG. 5 as a representation 60 with indicated safety area SB. The safety area SB marks the area in the image in which objects are comprehended as collision obstacles. Only the mast PL of the detected objects PL, BL, CL is located in the safety area SB. Only this mast PL is identified as a potential collision obstacle KH and monitored, for example with the aid of a tracking algorithm. If it is ascertained during tracking that the mast PL is not moving, and this is to be expected, then the mast PL is not classified as a potential collision obstacle KH either. The scenario shown in FIG. 6 corresponds to step 1. VIII in FIG. 1.

FIG. 7 shows ae schematic representation of an obstacle identification facility 70 according to one exemplary embodiment of the invention.

The obstacle identification facility 70 comprises a sensor data interface 71 represented on the left in FIG. 7. The sensor data interface 71 is embodied as a camera and is configured to receive 3D image data 3D-SD from a surrounding area U of a rail vehicle 81 (see FIG. 8) on which the obstacle identification facility 70 is arranged. Furthermore, the obstacle identification facility 70 also comprises a projection unit 72, which generates 2D image data 2D-BD on the basis of the 3D image data 3D-BD by way of a projection. The obstacle identification facility 70 also has a localization unit 73 for detecting and localizing rails S in the 2D image data. The obstacle identification facility 70 also includes a depth data ascertaining unit 74 for ascertaining depth data T in the 2D image data 2D-BD on the basis of the 3D image data 3D-BD. The obstacle identification facility 70 also comprises an allocation unit 75 for dividing the 2D image data 2D-BD into line-like image segments BS with one rail section respectively with a constant depth. The obstacle identification facility 70 also has a comparison unit 76, which is configured to compare the depth value T (P) of a pixel P of a line-like image segment BS outside of the rails S with the respective depth value T (S) of the rails S. A differential value ΔT of the depth values is ascertained and compared with a threshold value SW in the process.

The obstacle identification facility 70 also includes a detection unit 77. The detection unit 77 detects whether a pixel P is part of an object O projecting above the level of the terrain. This detection takes place as a function of whether the difference ΔT of the depth values overshoots the predetermined threshold value SW. If it is detected that the pixel P is part of an object O, an obstacle ascertaining unit 78, which is also part of the obstacle identification facility 70, ascertains whether the object O represents a potential collision obstacle KH. This ascertainment takes place as a function of whether properties of a collision obstacle KH are to be allocated to the object O. These properties can be, for example, its position in a safety area SB, or relate to its movement and direction of movement. For example, monitoring the trajectory of the detected object O is carried out for ascertaining the movement of the object O.

FIG. 8 illustrates a schematic representation 80 of a rail vehicle 81 according to one exemplary embodiment of the invention. The rail vehicle 81 schematically illustrated on the left in FIG. 8 travels from left to right in the direction of the arrow on a track system GK and captures three-dimensional image data 3D-BD from a surrounding area U located in front of the rail vehicle 81. For this, the rail vehicle 81 comprises a camera unit 82 in its front area. The 3D image data 3D-BD is transmitted to an obstacle identification facility 70, which is also part of the rail vehicle 68 and has the construction illustrated in FIG. 7. On the basis of the 3D image data 3D-BD, the obstacle identification facility 70 accordingly ascertains that a collision obstacle KH is situated in the environment, more precisely, on the right-hand rail of the track system GK shown in FIG. 8. This result KH is transmitted to a control facility 83 incorporated by the rail vehicle 81, which, in response to this collision obstacle KH, transmits control commands to individual functional units of the rail vehicle 81. For example, braking of the rail vehicle 81 is actuated to bring the rail vehicle 81 to a stop before the collision obstacle.

To conclude, reference is made once again to the fact that the previously described methods and apparatuses are merely preferred exemplary embodiments of the invention, and that the invention can be varied by a person skilled in the art without departing from the scope of the invention insofar as it is specified by the claims. For the sake of completeness, reference is also made to the fact that use of the indefinite article “a” or “an” does not preclude the relevant features from also being present multiple times. Similarly, the term “unit” does not preclude this from comprising a plurality of components, which can possibly also be spatially distributed.

1-12. (canceled)

13. A method for obstacle identification for a rail vehicle, the method comprising:
capturing 3D image data from a surrounding area of the rail vehicle;
generating 2D image data on a basis of the 3D image data;
detecting and localizing rails in the 2D image data;
ascertaining depth data in the 2D image data on a basis of the 3D image data;
dividing the 2D image data into line-shaped image segments each having a respective rail section with a constant depth;
comparing a depth value of a pixel of a line-shaped image segment outside of the rails with the respective depth value of the rails;
detecting whether the pixel is part of an object that projects above a level of a terrain, being a function of whether a difference between the depth value of the pixel and the depth value of the rails overshoots a predetermined threshold value; and
when the pixel is detected as part of an object that projects above the level of the terrain, ascertaining whether the object represents a potential collision obstacle, as a function of at least one of a position or a detected movement of the object.

14. The method according to claim 13, which comprises localizing the rails by semantic segmentation based on a Deep Learning method.

15. The method according to claim 13, which comprises capturing the 3D image data by a stereo camera.

16. The method according to claim 13, which comprises dynamically capturing the 3D image data by a mono camera.

17. The method according to claim 13, wherein the 3D image data comprises RGB data.

18. The method according to claim 13, which comprises ascertaining the depth data by way of a model, which is based on machine learning.

19. The method according to claim 13, which comprises capturing potential obstacles by removing the level of the terrain.

20. The method according to claim 13, which comprises defining a portion of the 2D image data as a safety area and investigating only the safety area for potential collision obstacles.

21. An obstacle identification facility, comprising:
a sensor data interface for receiving 3D image data from a surrounding area of a rail vehicle;
a projection unit for generating 2D image data on a basis of the 3D image data;
a localization unit for detecting and localizing rails in the 2D image data;
a depth data ascertaining unit for ascertaining depth data in the 2D image data on a basis of the 3D image data;
an allocation unit for dividing the 2D image data into line-shaped image segments each with a rail section at a constant depth value;
a comparison unit for comparing a depth value of a pixel of a line-shaped image segment outside of the rails with the respective depth value of the rails;
a detection unit for detecting whether a pixel is part of an object that projects above a level of a terrain, as a function of whether a difference between the depth value of the pixel and the depth value of the rails exceeds a predetermined threshold value; and
an obstacle ascertaining unit configured to ascertain, in a case in which the pixel was detected as part of an object that projects above the level of the terrain, whether the object represents a potential collision obstacle, as a function of at least one of a position or a detected movement of the object.

22. A rail vehicle, comprising:
a sensor unit for capturing von 3D image data from the environment of the rail vehicle;
an obstacle identification facility according to claim 21, with the sensor data interface connected to receive the 3D image data from said sensor unit; and
a control facility for controlling a driving behavior of the rail vehicle as a function of whether said obstacle identification facility has identified an obstacle in the environment of the rail vehicle.

23. A computer program product with a computer program containing computer-readable code to be loaded directly into a memory unit of a control facility of a rail vehicle, with program segments, configured to carry out the steps of the method according to claim 13 when the computer program is executed in the control facility.

24. A non-transitory computer-readable medium having stored thereon program segments, to be executed by a computer unit, in order to carry out all steps of the method according to claim 13 when the program segments are executed by the computer unit.
